(19) United States
(12) Patent Application Publication
(10) Pub. No.: US 2007/0250676 A1
(43) Pub. Date: Oct. 25, 2007

(54) Device for Controlling a Memory

(75) Inventors: Stephan Lietz, Bad Salzdetfurth (DE); Thomas Eymann, Hildesheim (DE); Christoph Kunze, Sibbesse (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 10/581,587

(22) PCT Filed: Nov. 19, 2004
(86) PCT No.: PCT/EP04/53009

§ 371 Date: Jun. 8, 2007

(30) Foreign Application Priority Data
Dec. 2, 2003 (DE) 103 56 127.7

(51) Int. Cl. G06F 13/00

(52) U.S. Cl. 711/165

(57) ABSTRACT

A memory in a network bridge is subdivided into a plurality of memory areas for different types of data, the memory areas being designed to be configurable independently of one another, and means are provided both for presetting the individual memory areas and for dynamic modification, during operation, with regard to the size of the individual memory areas and/or the number of memory areas assignable to the different types of data.

### FIELD OF THE INVENTION

The present invention relates to a device for controlling a memory, in particular for data to be transported via a network bridge.

### BACKGROUND INFORMATION

According to FIG. 1, networks according to IEEE 1394 are made up of a number of nodes K1 . . . Kn in the network whose theoretically maximum number is limited to 63 by the length of the corresponding node ID (identification). The node ID for addressing the individual nodes has a length of 6 bits; the 0xFF address is reserved as broadcast address. In the event that more than 63 nodes are to be connected, it is possible to connect a plurality of separate busses B1, B2 via a network bridge NB (bus bridge). These buses may in turn be addressed individually via a bus ID. The bus ID has a length of 10 bits, which corresponds to 1024 buses. Theoretically, 1024*63 nodes, i.e., 64,512 nodes, can be connected to a network system in this manner.

A serial bus according to IEEE 1394 supports the transmission of asynchronous and isochronous data. While the receipt of asynchronous data packets must be acknowledged by the receiving nodes in order to ensure reliable data transmission, no receipt is required for isochronous data. Bus bridges for the coupling of a plurality of buses have to support the transmission of both types of data. At the same time, given more complex topologies, they must ensure that each data packet is able to reach its recipient and that all buses connected within the network system are operating at a synchronized cycle. The draft standard IEEE 1394.1 specifies the functionality of such a high performance serial bus bridge to be used specifically in networks according to IEEE 1394 b.

### SUMMARY OF THE INVENTION

The device includes the features:
the memory is subdivided into a plurality of memory areas or is made up of a plurality of individual memories;
the memory areas/individual memories are designed to be configurable independently of each other;
means are provided both for preadjustment of the individual memory areas/individual memories and for dynamic modification with respect to the size and/or the number of individual memory areas/individual memories during operation;
these means allow both a static and dynamic management of the memory for data to be transported via the network bridge.

In networks with changing operating parameters, for instance varying data throughputs or varying packet sizes, it is therefore possible to configure and utilize the existing limited resources—the memory in the case in hand—in an optimal manner without any problems. This minimizes the complexity of the set-up of a universal network bridge while it simultaneously increases the performance of the network bridge. The present invention provides a flexible and dynamically changing memory size for the individual channels on which different types of data are transmitted, in particular isochronous and asynchronous channels. This enables the network bridge to adapt, in particular, the FIFO memory size for the isochronous and asynchronous channels, in accordance with the demands of the individual situation.

Especially advantageous is the insertion of an additional software layer in the network bridge (bridge) architecture. This bridge management and configuration layer may access a few or all functional blocks via suitable software interfaces and both read out data therefrom and modify parameters for the function of these blocks.

As a result, it is possible to calculate, for instance, statistics regarding different functional blocks within or above this software layer. Furthermore, using additional software layers situated above the management and configuration layer, the network operator or user is able to control the function of the network bridge directly or indirectly. In networks having changing operating parameters, for instance varying data throughputs or varying packet sizes, it is therefore possible to configure and utilize the existing limited resources, such as the memory and/or the output capacity, for instance, in an optimal manner without any problems. This minimizes the complexity of the set-up of such a network bridge while it simultaneously increases the performance of the network bridge.

From European Published Patent Application No. 0 933 900, a network bridge for an IEEE 1394 bus is known. However, the bridge manager provided there is not set up to assume the configuration and management of the functional blocks, which an IEEE 1394.1 written. No management level for the configuration of the individual functional blocks, in particular the memory, is disclosed there; at best, the method of functioning toward the outside. Important in the realization according to the present invention is the optimization of the internal method of functioning, which is to ensure that a network bridge according to IEEE 1394.1 may be set up using the simplest hardware possible. This hardware is subsequently (before or during operation) controllable by the software and may thus be utilized in the most flexible manner possible.

### BRIEF DESCRIPTION OF THE DRAWINGS

FIG. 1 shows a network according to IEEE 1394.

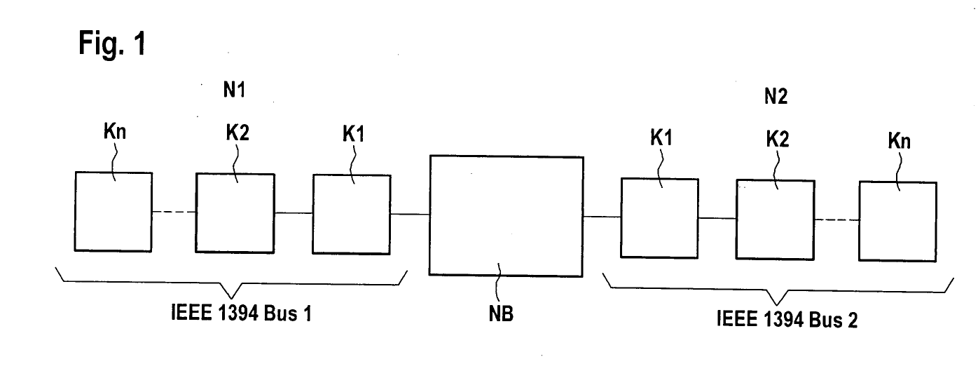

FIG. 2 shows an architecture model for a network bridge according to the present invention.

FIG. 3 shows the architecture model according to FIG. 2, including means for configuring and controlling the network bridge, and interfaces to the functional blocks of the network bridge.

FIG. 4 shows a dynamic memory block.

### DETAILED DESCRIPTION

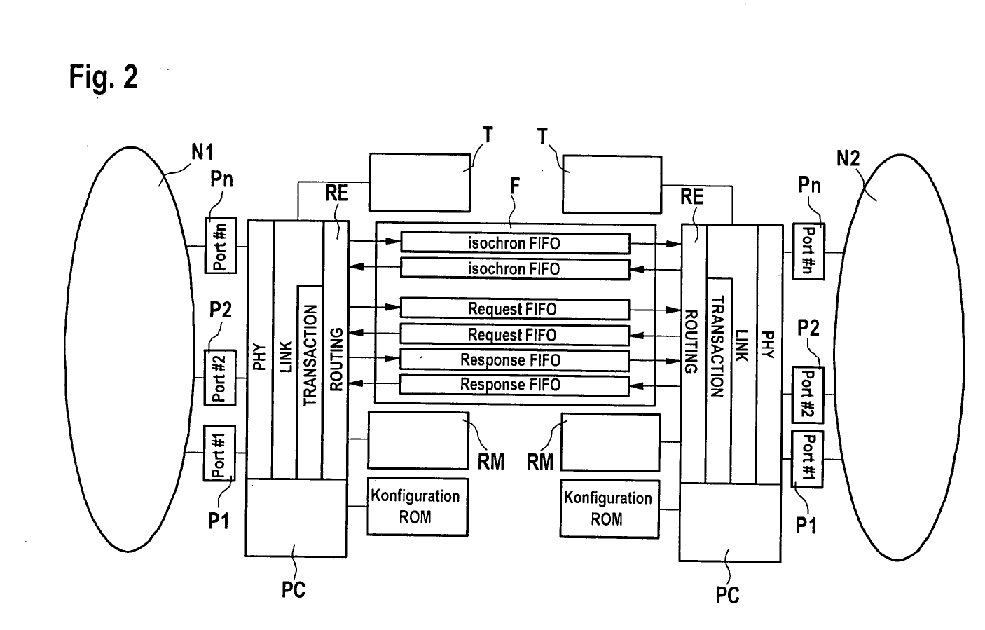

For a better understanding, the method of functioning of an architecture model for a network bridge according to IEEE 1394 draft version 1.04 will be introduced before the actual invention is described. The network bridge according to FIG. 2 is in each case connected to two independent networks N1, N2 via its ports P1, P2 . . . , and is able to receive and transmit data. In general, it will receive data from one network and transmit it to the other network. The functional blocks “port”, “configuration ROM”, “PHY”, “link”, and “transaction” correspond to those of a normal network node according to IEEE 1394. In addition, the network bridge has routing maps RM and a routing unit RE for each of the two networks. Routing maps RM have information available pertaining to the topology and node addresses of the individual networks, and data may be exchanged between the link or transaction layer and memory F of network bridge NB via routing unit RE. According to IEEE 1394.1, memory F is made up of a number of individual FIFOs, which buffer-store data that are to be transported from one bus to another. The network bridge also has an internal timer T (cycle timer), which enables it to synchronize the cycles in both buses.

The control of routing units RE and also of functional blocks “port”, “configuration ROM”, “PHY”, “link”, and “transaction” is implemented via the functional units “portal control” PC.

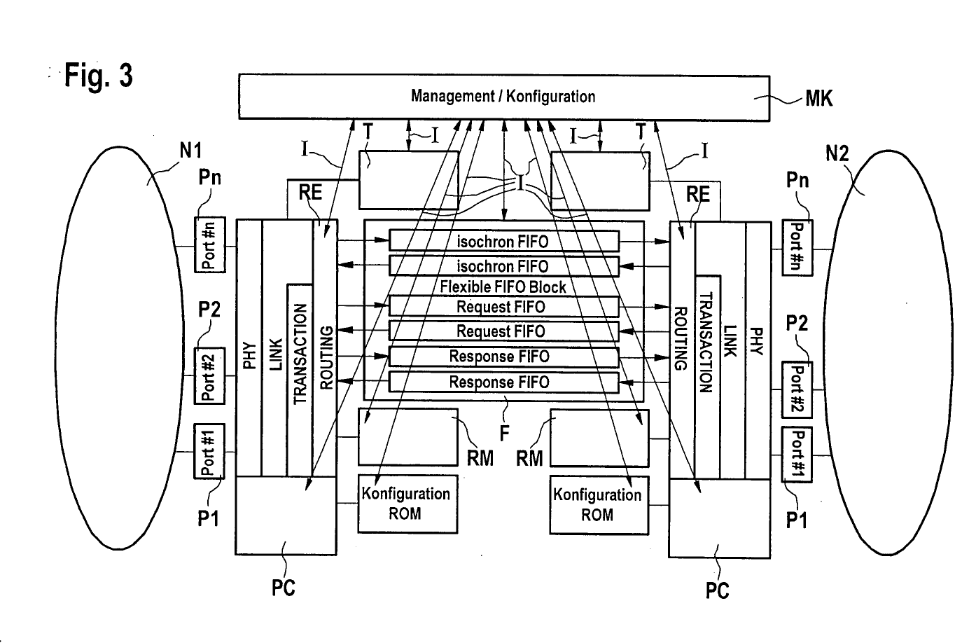

According to the present invention, each functional block in FIG. 3 has one additional interface I via which the data are able to be read and/or written. Using this interface I, management and configuration layer MK according to the present invention, which may be embodied as hardware and software, is able to manipulate statistical data, useful data or parameters for the operation of the functional blocks. Due to the collection of different data, the software layer according to the present invention is able to produce statistics regarding the ongoing operation of the network bridge within a short time. The statistics may in turn be utilized to optimize the operation of the functional blocks by, for instance, modifying parameters within the functional blocks. A network according to IEEE 1394 in which mostly isochronous data such as audio and video streams are transmitted intermittently and mostly asynchronous data are transmitted intermittently, shall serve as an example. Via statistical analyses, management and configuration layer MK or superposed software layers is/are able to determine that the asynchronous data portion of the overall occurring data is increasing heavily. It is then possible to reconfigure flexible FIFO block F or set corresponding inputs for it for an automatic reconfiguration, in such a way that the memory areas are reduced for isochronous data and increased for asynchronous data. This allows a rapid response of the network bridge to changes, and does not require it to have permanent memory areas available for isochronous and asynchronous data throughputs.

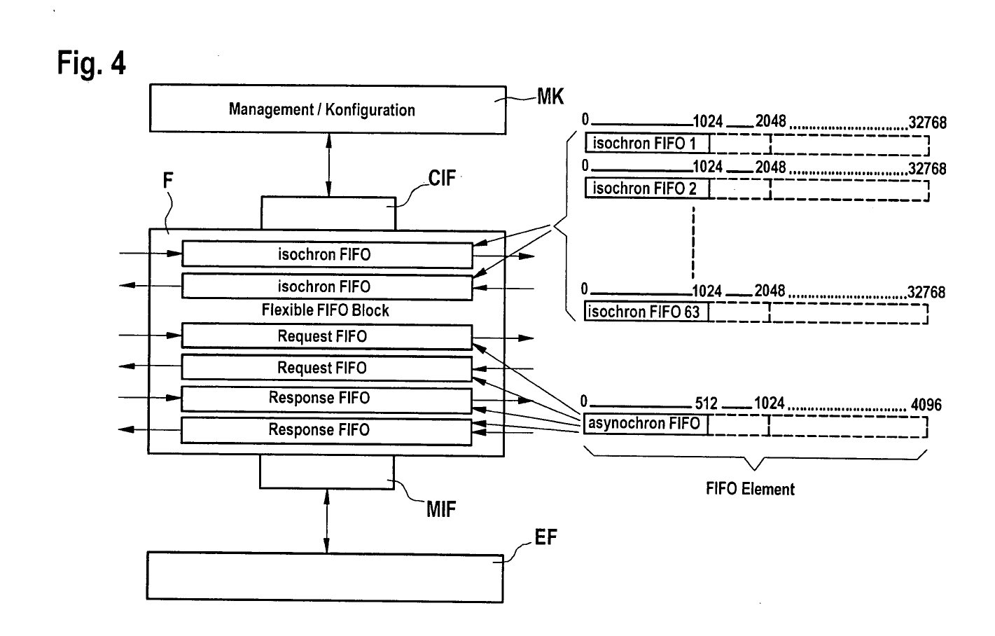

Dynamic memory F according to the present invention (flexible FIFO block) as illustrated in FIG. 4, is made up of a plurality of so-called FIFO elements. The size of these FIFO elements is able to be configured independently of each other. The configuration of this size and also of all additional settings for the FIFO block is implemented via an interface CIF (control IF), originating from control entity MK of the network bridge (bridge management configuration layer). The size of the FIFO elements is based on the data rate (S100, S200, etc.) and thus the packet size. For the isochronous channels the size of a FIFO element may be 1024 bytes at S100 to 32768 bytes at S3200; for the asynchronous channels it may range from 512 bytes at S100 to 4096 bytes at S3200. For the asynchronous channels, request FIFO units are provided for conveying the data from one bus to the other, and response FIFO units for acknowledgement. Furthermore, depending on the required isochronous channels, the number of the FIFO elements required for that purpose may vary. This means that, given a maximum of 63 isochronous channels in one direction, maximally 126 isochronous FIFO elements are possible for the memory. If the maximally required overall memory size is not available in the network bridge, there is the option of additionally connecting a further external memory EF such as an SDRAM to the network bridge, via an interface MIF at the memory, in order to increase the overall size of dynamic memory F.

It must be differentiated between two possible application cases of dynamic memory F:
a) the settings of dynamic memory F, such as the size and number of FIFO elements, occur statically, i.e., they are predefined once by network bridge (bridge management configuration layer) MK, prior to operation of the bus, and then remain unchanged during operation (preadjustment). “Prior to operation” also includes the instant after a bus reset, i.e., whenever the number of nodes on the bus is changed, the settings may be changed as well.
b) The settings may be changed dynamically, i.e., using dynamic memory F, it is possible to ascertain the data flow, the data rate, and thus the required memory area. On the basis of this information, the size and the number of FIFO elements may be adapted to the instantaneous requirements even while the bus is operating.

Interactivity with the control entity of network bridge MK via an interface CIF (control IF) is provided for both application cases. Data may be read and/or written via this route. Furthermore, control entity MK is able to manipulate statistical data, useful data or parameters for the operation of dynamic memory F. Due to the collection of different data, including data of other functional blocks such as “portal control” PC or “route maps” RM (cf. FIG. 3 in this context), control entity MK is able to generate statistics regarding the ongoing operation of the network bridge within a short time. They may in turn be utilized to optimize the operation of the functional blocks, including memory F, by modifying parameters within the functional blocks, for instance.

Instead of the previously described subdivision of the memory area of memory F, it is for course also possible that memory F is made up of individual memories, which are correspondingly assigned to the different types of data in accordance with the specific amount of occurring data.

1.-5. (canceled)

6. A device for controlling a memory, comprising:
a memory one of subdivided into a plurality of memory areas and including a plurality of individual memories, the one of the memory areas and individual memories configurable independently of each other; and
an arrangement for preadjusting the one of the memory areas and individual memories, and for performing a dynamic modification with respect to at least one of a size and a number of the one of the memory areas and the individual memories, during operation.

7. The device as recited in claim 6, wherein the device is for data to be transported via a network bridge.

8. The device as recited in claim 7, further comprising:
an arrangement for configuring and controlling the network bridge so as to query data, analyze data, and obtain parameters for operating the memory on the basis of analysis;
an interface via which the memory is connected via an interface to the arrangement for configuring and controlling means.

9. The device as recited in claim 8, wherein the analysis is with respect to a memory division and occupancy by different types of data in the memory.

10. The device as recited in claim 6, further comprising:
an interface via which the memory is able to be connected to an external memory in order to thereby increase an overall size of the memory.

11. The device as recited in claim 8, further comprising:
at least one additional interface via which the arrangement for configuring and controlling is able to be connected to additional functional blocks of the network bridge, in order to collect and analyze data, and in order to modify parameters within the additional functional blocks, including the memory, as a function thereof.

12. The device as recited in claim 8, wherein the arrangement for configuring and controlling includes a software layer within a network bridge architecture.
